(19) United States
(12) Patent Application Publication
(10) Pub. No.: US 2007/0076732 A1
(43) Pub. Date: Apr. 5, 2007

(54) Multi-protocol label switching (MPLS) network and method of applying a mobile Internet protocol (IP) to MPLS network

(76) Inventor: Jin-Hyoung Kim, Hwaseong-si (KR)

Correspondence Address: Robert E. Bushnell, Suite 300, 1522 K Street,, Washington, DC, 20005-1202, US

(21) Appl. No.: 11/519,903

(22) Filed: Sep. 13, 2006

(30) Foreign Application Priority Data
Sep. 14, 2005 (KR) 10-2005-0085922

(51) Int. Cl. H04L 12/56

(52) U.S. Cl. 370/409

(57) ABSTRACT

In a Multi-Protocol Label Switching (MPLS) network and a method of applying a mobile IP to the MPLS network, the method includes: performing label assignment using a label-tunnel configured by doubly stacking a label between a first edge router and a second edge router upon a Mobile Node (MN) moving from a position of the first edge router to a position of the second edge router; and including label mapping information based on the assigned label in a registration request message in the second edge router, and transmitting the included label mapping information from the second edge router to the first edge router.

### CLAIM OF PRIORITY

This application makes reference to, incorporates the same herein, and claims all benefits accruing under 35 U.S.C. §119 from an application for MPLS NETWORK AND METHOD FOR APPLYING MOBILE IP TO MPLS NETWORK earlier filed in the Korean Intellectual Property Office on the 14 of Sep. 2005 and there duly assigned Ser. No. 10-2005-0085922.

### BACKGROUND OF THE INVENTION

1. Field of the Invention

The present invention relates to a multi-protocol label switching (MPLS) network and a method for applying mobile Internet Protocol (IP) to the MPLS network, and more specifically, to an MPLS network and a method for applying mobile IP to the MPLS network that reduce a number of entries of a label forwarding information base (LFIB) and a routing look-up process using a label stack in an MPLS-based network.

2. Description of the Related Art

In a communication mode of an Internet protocol (IP)-based network, routing for transmitting a packet with reference to a destination address included in the packet is performed. A host address is assigned to a fixed point in the network. If a destination of the packet is a Mobile Node (MN), a new IP address should be assigned every time at each connection point changing upon movement. In a transmission control protocol (TCP) hierarchy, a connection set with the new IP address assigned means a new connection, and therefore mobility is not supported.

Mobile IP is a protocol for solving the drawback of not supporting an Internet service in a mobile host, and is a technology for, when a user moves from one network to another, maintaining a connection of his/her assigned IP address with an IP network as is. For this, when the mobile IP is used, a MN has two IP addresses. One of the two IP addresses is a home address, which is a unique inherent identification address for identifying the MN. The other address is a Care-of-Address (CoA), which is an IP address used as a forwarding address when the MN accesses an external network, and changes at each new connection point.

An exemplary wireless network using mobile IP includes a Mobile Node (MN), a Correspondent Node (CN), a Home Agent (HA), and a Foreign Agent (FA).

The MN is a host, which moves by changing an accessed network, and the CN is for communicating with the MN. The HA accesses a home network of the MN, and the FA is connected to a network to which the MN is currently accessing outside of the home network.

For example, a home address assigned to the MN is 10.10.10.2, and a CoA is 20.20.20.1 which is identical to an IP address of the FA. Assume that the MN is moving from an area of the HA to an area of the FA. The HA registers and manages the home address and the CoA of the MN in a format of the mobility binding table.

In communication of the MN with the CN, the CN, aware of the home address of the MN, encapsulates data to be transmitted to the MN using home address information of the MN. The encapsulated data is transmitted to the HA of the MN depending on the home address information. The HA once again encapsulates reception data using the stored CoA of the MN, and then transmits the encapsulated data to the MN.

The operation flow of the mobile IP when a terminal moves is as follows. The FA, positioned in an area where the MN moves to, performs agent advertisement and leads registration of the MN. If it is determined that the MN receiving the agent advertisement is in an external network, the MN transmits a registration request to the HA through the FA. The HA receives the registration request and stores a position of the MN, and then transmits a registration reply to the FA. After the FA receives the registration reply from the HA and creates a visitor list, the FA transmits the registration reply to the MN.

When transmitting the packet to the MN, the CN transmits the packet to the HA along a general routing path. The HA receives the packet from the CN and tunnels the packet to the CoA of the MN with reference to a binding list including a position of the MN. The FA receives the tunneled packet, de-tunnels a corresponding packet, and transmits the corresponding packet to the MN with reference to the visitor list.

The above routing of the Internet network is based on checking a header of each IP packet, determining a next hop, and transmitting the packet to the next hop. In this method, a header must be checked at each packet as well as in all routers within a routing path. Therefore, traffic processing is inefficient. Unlike a transmission type router, in MPLS, the packet is transmitted using a short and fixed-length label, without passing through three hierarchies.

The MPLS mainly relating to packet forwarding is a combination of simplicity of an IP routing and capability of high-speed switching of an Asynchronous Transfer Mode (ATM). In an MPLS network, a packet having a short-length label is transmitted through a path generally called a Label Switching Path (LSP), thereby simplifying packet transmission and making it possible to control traffic flow through traffic engineering.

In the MPLS, a Forwarding Equivalence Class (FEC) is classified with a key of the same destination IP address on the basis of a forwarding table created by a routing protocol, and the same label is assigned to a routing entry belonging to the same FEC so that packets having the same destination can have the same label and be transmitted to a destination at a high speed using label exchange.

A connection structure of the MPLS network is comprised of an end system performing the function of a router and a Label Switching Router (LSR) and can be classified as an edge LSR (that is, a Label Edge Router (LER)) positioned at a contact point with a given network and a center LSR positioned within a corresponding MPLS network. The LSP is set in an edge LSR of a corresponding LSP. IP tunneling puts an IP datagram inside an IP datagram and can surround and redirect a datagram previously forwarded to one IP address, to another IP address.

In such a network, one packet is mapped to one FEC at each router, whereas in the MPLS, this mapping operation is performed only in an ingress router of an MPLS domain. In the FEC for setting the LSP in the MPLS for the IP network, there is a method of determining all IP prefixes with the same egress router which is the destination by one FEC, and a method of determining each IP destination address field of a routing table by the FEC.

A general flow of setting the LSP in the MPLS network is as follows. When a plurality of MNs are positioned in an area of the HA, an LSP from an LERI, which is the edge router using the host FEC, to an LER2 is set and a Label Forwarding Information Base (LFIB) is set in each router. The HA and the FA are operated as edge routers. The MNs , having addresses of 1.1.1.2, 1.1.1.3, and 1.1.1.4, are positioned in the LER2 which is the HA.

In each router, the LSP is set as an MN having a prefix of 32 bits. This is to manage an LFIB entry for each MN when the MN moves. The LFIB is a table of which method a frame is to be transmitted for a label value created by the LSR performing a function of label switching.

When the three MNs are registered in the LER2, three labels are required in each router. This means that, when there are N MNs, N labels are required in each router.

A packet flow is as follows. When the MN is not out of the HA area, the label is no longer assigned for the address of 1.1.1.3 in the LFIB table of the LER2. In contrast, when the MN moves from the HA to FA, a label (L8) is again assigned for the address of 1.1.1.3 (address of MN), and the packet is transmitted to a LER3 through a middle router.

The middle router positioned between the LER and the LER3 attaches a label (L7) to the packet input with the label (L8) attached, and transmits the packet to the LER3. The LER3 receives the packet, pops out the label (L8) from the received packet, performs IP routing, and transmits the packet to the MN.

An operation flow for setting the LSP between agents when the MN moves is as follows. The MN moves from an area of the LER2 to an area of the LER3, receives the agent advertisement from the FA, and transmits a registration request message to the HA through the FA, thereby informing a new FA of its movement. The HA receives the registration request message, and requests the FA to set the LSP to a Label Distribution Protocol (LDP). The FEC is a CoA IP address of the MN, that is, the FA.

When the LDP of the LER3 receives the label request message, the LDP transmits a label mapping message to the LER2. The LER2 pops out an out label for FEC 1.1.1.3 of its own LFIB table, and changes the out label to have a number of the assigned label. The assigned label will be the label (L8). In this manner, the LER2 transmits the packet to the LER3 through MPLS packet forwarding for FEC 1.1.1.3.

Summarizing the procedure above, it can be appreciated that four steps of registration request, label request, label mapping, and registration reply are performed.

When the LSP is set using the host FEC and the MN moves, only the table of the LFIB changes, thereby making it possible to transmit the packet from the HA to the FA.

However, if the LSP is set using the host FEC (32 bits of prefix length), the LFIB table entry is increased in the middle routers positioned between the edge routers, thereby causing a drawback in extension. In order to overcome this drawback, a method of setting the LSP using a prefix FEC, not the host FEC, is used. However, even in this method, the edge router requires a procedure of referring to the LFIB table and a Routing Information Base (RIB), and therefore there is a drawback of increased time taken for packet forwarding.

### SUMMARY OF THE INVENTION

It is, therefore, an objective of the present invention to provide a Multi-Protocol Label Switching (MPLS) network and a method of applying a mobile Internet Protocol (IP) in the MPLS network that sets an additional label-tunnel in addition to an in label between edge routers, thereby performing packet transmission between an MN and a correspondent node.

According to one aspect of the present invention, a method of applying a mobile IP to an MPLS network is provided, the method including: performing label assignment using a label-tunnel configured by doubly stacking a label between a first edge router and a second edge router upon a Mobile Node (MN) moving from a position of the first edge router to a position of the second edge router; and including label mapping information based on the assigned label in a registration request message in the second edge router, and transmitting the included label mapping information from the second edge router to the first edge router.

The label-tunnel is preferably configured by doubly stacking an in label assigned at each host Forwarding Equivalence Class (FEC) and a tunnel label assigned for a prefix FEC.

The label mapping information preferably includes at least one of a prefix length, information on a FEC for assigning the label, and information on the label assigned to the FEC.

The label assignment preferably includes: transmitting the registration request message to the second edge router from the MN; and receiving the registration request message and performing a Label Distribution Protocol (LDP) label assignment in the second edge router.

The method preferably further includes: receiving the label mapping information and configuring a label forwarding table in the first edge router; normally completing configuration of the label forwarding table in the first edge router, and transmitting a registration reply message from the first edge router to the second edge router; and transmitting the registration reply message from the second edge router to the MN.

The label forwarding table is preferably configured using at least one of an IP address of the MN, an IP address of the second edge router, and the label mapping information.

The method preferably further includes: performing the label assignment based on the label-tunnel and setting a label switching path between the first edge router and a third edge router where a correspondent node communicating with the MN is positioned; and transmitting a packet from the correspondent node to the MN through the label switching path set between the first and second edge routers, and between the second and third edge routers.

Transmitting a packet from the correspondent node to the MN preferably includes: receiving the packet from the first edge router in a middle router positioned one hop before the second edge router, popping out a tunnel label of a corresponding packet, and transmitting the corresponding packet to the second edge router; and referring to an in label included in the received packet in the second edge router and transmitting the packet from the second edge router to the MN.

According to another aspect of the present invention, a method of applying mobile Internet Protocol (IP) to a Multi-Protocol Label Switching (MPLS) network is provided, the method including: performing label assignment using a label-tunnel configured by doubly stacking a label between a first edge router and a second edge router upon a Mobile Node (MN) moving from a position of the first edge router to a position of the second edge router; including label mapping information based on the assigned label in a registration request message in the second edge router, and transmitting the included label mapping information from the second edge router to the first edge router; receiving the label mapping information and configuring a label forwarding table in the first edge router; normally completing configuration of the label forwarding table in the first edge router and transmitting a registration reply message from the first edge router to the second edge router; and transmitting the registration reply message from the second edge router to the MN.

The label-tunnel is preferably configured by doubly stacking an in label assigned at each host Forwarding Equivalence Class (FEC) and a tunnel label assigned for a prefix FEC.

The label mapping information preferably includes at least one of a prefix length, FEC information for assigning the label, and information on the label assigned to the FEC.

The label forwarding table is preferably configured using at least one of an IP address of the MN, an IP address of the second edge router, and the label mapping information.

The method preferably further includes: performing the label assignment based on the label-tunnel and setting a label switching path between the first edge router and a third edge router where a correspondent node communicating with the MN is positioned; receiving the packet from the first edge router in a middle router positioned one hop before the second edge router, popping out a tunnel label of a corresponding packet, and transmitting the corresponding packet to the second edge router; and referring to an in label included in the received packet in the second edge router and transmitting the packet from the second edge router to the MN.

According to still another aspect of the present invention, a Multi-Protocol Label Switching (MPLS) network is provided including: a Mobile Node (MN); a first edge router adapted to receive a registration request message from the MN, to perform label assignment using a label-tunnel configured by doubly stacking a label, and to include and transmit label mapping information based on the assigned label in the registration request message upon the MN moving within its own service area; and a second edge router adapted to receive the registration request message from the first edge router, to configure a label forwarding table based on the label mapping information included in the received registration request message, and to transmit a registration reply message to the first edge router upon the MN moving out of its own service area.

The label-tunnel is preferably configured by doubly stacking an in label assigned at each host Forwarding Equivalence Class (FEC) and a tunnel label assigned for a prefix FEC.

The label mapping information preferably includes at least one of a prefix length, FEC information for assigning the label, and information on the label assigned to the FEC.

The label forwarding table is preferably configured using at least one of an IP address of the MN, an IP address of the second edge router, and the label mapping information.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an example of a wireless network using mobile Internet Protocol (IP);

FIG. 2 is an operation flow of mobile IP when a terminal moves;

FIG. 3 is a general flow of setting a Label Switching Path (LSP) in a multi-protocol label switching (MPLS) network;

FIG. 4 is a packet flow when a Mobile Node (MN) moves in an MPLS network;

FIG. 5 is an operation flow of setting an LSP between agents when an MN moves;

FIG. 6 is a flow of setting an LSP using a prefix Forwarding Equivalence Class (FEC) according to the present invention;

FIG. 7 is a procedure of referring to a routing table in setting an LSP using a prefix FEC;

FIG. 8 is the structure of label mapping information according to an embodiment of the present invention;

FIG. 9 is an LSP structure for an MPLS-based mobile IP according to an embodiment of the present invention;

FIG. 10 is a procedure of setting an LSP for an MPLS-based mobile IP according to an embodiment of the present invention;

FIG. 11 is an LSP structure according to an embodiment of the present invention when an MN moves; and

FIG. 12 is a procedure of distributing a label between a home agent (HA) and a Foreign Agent (FA) when an MN moves.

### DETAILED DESCRIPTION OF INVENTION

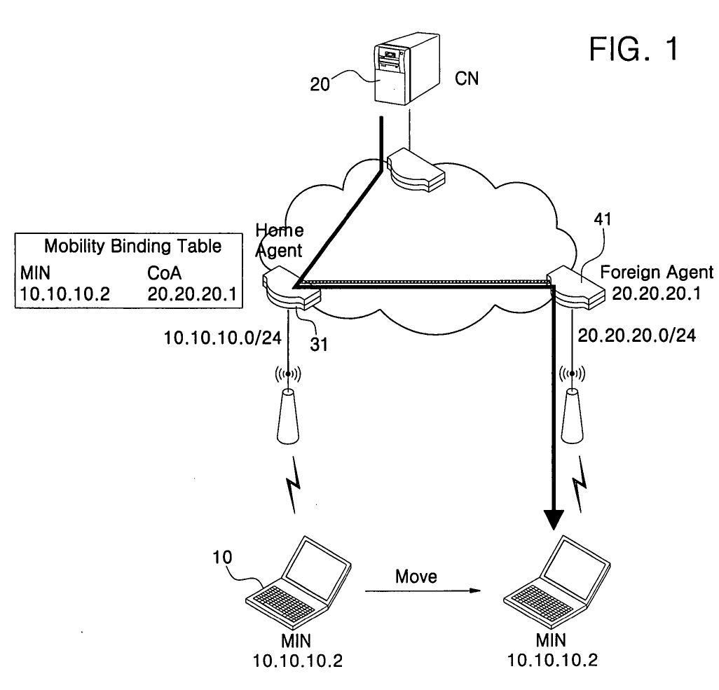

FIG. 1 is an example of a wireless network using mobile Internet Protocol (IP). The wireless network of FIG. 1 includes a Mobile Node (MN) 10, a Correspondent Node (CN) 20, a Home Agent (HA) 31, and a Foreign Agent (FA) 41.

The MN 10 is a host, which moves by changing an accessed network, and the CN 20 is for communicating with the MN. The HA 30 accesses a home network of the MN 10, and the FA 40 is connected to a network to which the MN 10 is currently accessing outside of the home network.

In FIG. 1, an HA assigned to the MN is 10.10.10.2, and a Care-of-Address (CoA) is 20.20.20.1 which is identical to an IP address of the FA 41. In FIG. 1, the MN 10 is moving from an area of the HA 31 to an area of the FA 41. The HA 31 registers and manages the home address and the CoA of the MN 10 in a format of the mobility binding table.

In communication of the MN 10 with the CN 20, the CN 20, aware of the home address of the MN 10, encapsulates data to be transmitted to the MN 10 using home address information of the MN 10. The encapsulated data is transmitted to the HA 31 of the MN 10 depending on the home address information. The HA 31 once again encapsulates reception data using the stored CoA of the MN 10, and then transmits the encapsulated data to the MN 10.

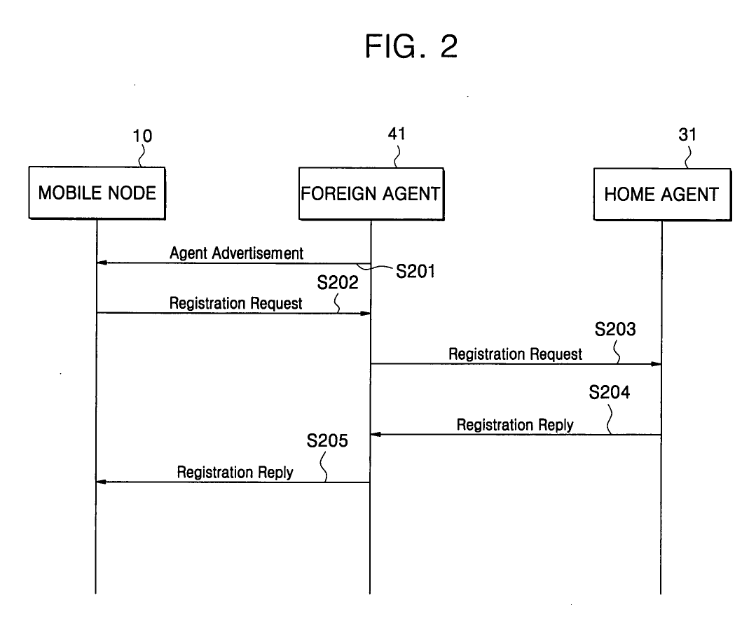

FIG. 2 is an operation flow of the mobile IP when a terminal moves. The FA 41, positioned in an area where the MN moves to, performs agent advertisement and leads registration of the MN 10 (Step 201). If it is determined that the MN 10 receiving the agent advertisement is in an external network, the MN 10 transmits a registration request to the HA 31 through the FA 41 (Steps 202 and 203). The HA 31 receives the registration request and stores a position of the MN 10, and then transmits a registration reply to the FA 41 (Step 204). After the FA 41 receives the registration reply from the HA 31 and creates a visitor list, the FA 41 transmits the registration reply to the MN 10 (Step 205).

When transmitting the packet to the MN 10, the CN 20 transmits the packet to the HA 31 along a general routing path. The HA 31 receives the packet from the CN 20 and tunnels the packet to the CoA of the MN 10 with reference to a binding list including a position of the MN 10. The FA 41 receives the tunneled packet, de-tunnels a corresponding packet, and transmits the corresponding packet to the MN 10 with reference to the visitor list.

The above routing of the Internet network is based on checking a header of each IP packet, determining a next hop, and transmitting the packet to the next hop. In this method, a header must be checked at each packet as well as in all routers within a routing path. Therefore, traffic processing is inefficient. Unlike a transmission type router, in MPLS, the packet is transmitted using a short and fixed-length label, without passing through three hierarchies.

The MPLS mainly relating to packet forwarding is a combination of simplicity of an IP routing and capability of high-speed switching of an Asynchronous Transfer Mode (ATM). In an MPLS network, a packet having a short-length label is transmitted through a path generally called a Label Switching Path (LSP), thereby simplifying packet transmission and making it possible to control traffic flow through traffic engineering.

In the MPLS, a Forwarding Equivalence Class (FEC) is classified with a key of the same destination IP address on the basis of a forwarding table created by a routing protocol, and the same label is assigned to a routing entry belonging to the same FEC so that packets having the same destination can have the same label and be transmitted to a destination at a high speed using label exchange.

A connection structure of the MPLS network is comprised of an end system performing the function of a router and a Label Switching Router (LSR), and can be classified as an edge LSR (that is, a Label Edge Router (LER)) positioned at a contact point with a given network and a center LSR positioned within a corresponding MPLS network. The LSP is set in an edge LSR of a corresponding LSP. IP tunneling puts an IP datagram inside an IP datagram and can surround and redirect a datagram previously forwarded to one IP address, to another IP address.

In such a network, one packet is mapped to one FEC at each router, whereas in the MPLS, this mapping operation is performed only in an ingress router of an MPLS domain. In the FEC for setting the LSP in the MPLS for the IP network, there is a method of determining all IP prefixes with the same egress router which is the destination by one FEC, and a method of determining each IP destination address field of a routing table by the FEC.

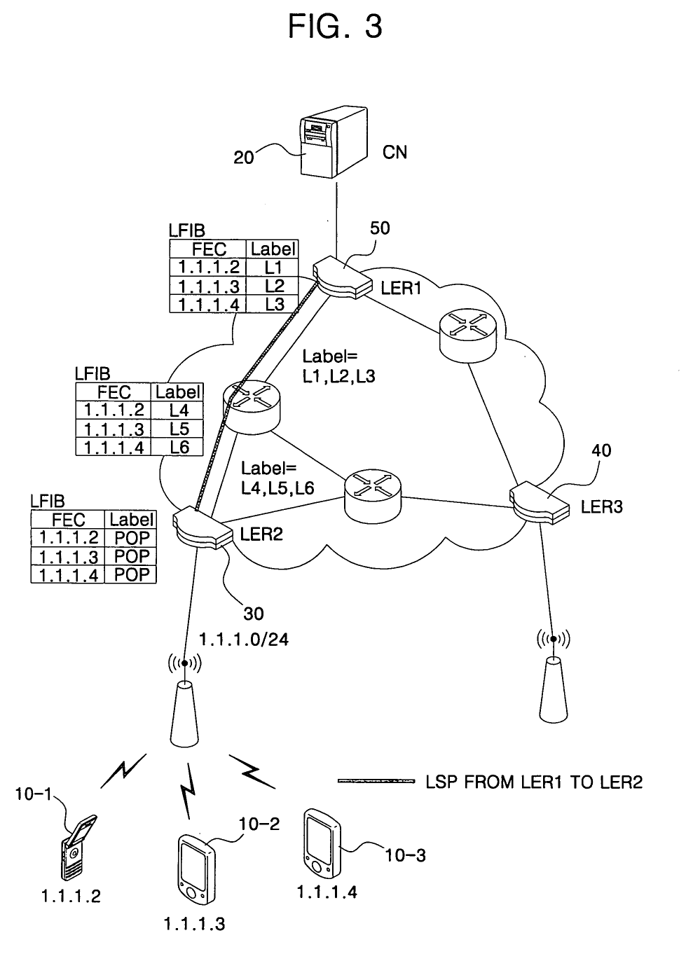

FIG. 3 is a general flow of setting the LSP in the MPLS network. FIG. 3 shows that, when a plurality of MNs are positioned in an area of the HA 10, an LSP from an LERI 50, which is the edge router using the host FEC, to an LER2 30 is set and a Label Forwarding Information Base (LFIB) is set in each router. The HA and the FA are operated as edge routers. The MNs 10-1, 10-2, and 10-3, having addresses of 1.1.1.2, 1.1.1.3, and 1.1.1.4, are positioned in the LER2 30 which is the HA.

In each router, the LSP is set as an MN having a prefix of 32 bits. This is to manage an LFIB entry for each MN when the MN moves. The LFIB is a table of which method a frame is to be transmitted for a label value created by the LSR performing a function of label switching.

As confirmed in FIG. 3, when the three MNs 10-1, 10-2, and 10-3 are registered in the LER2 30, three labels are required in each router. This means that, when there are N MNs, N labels are required in each router.

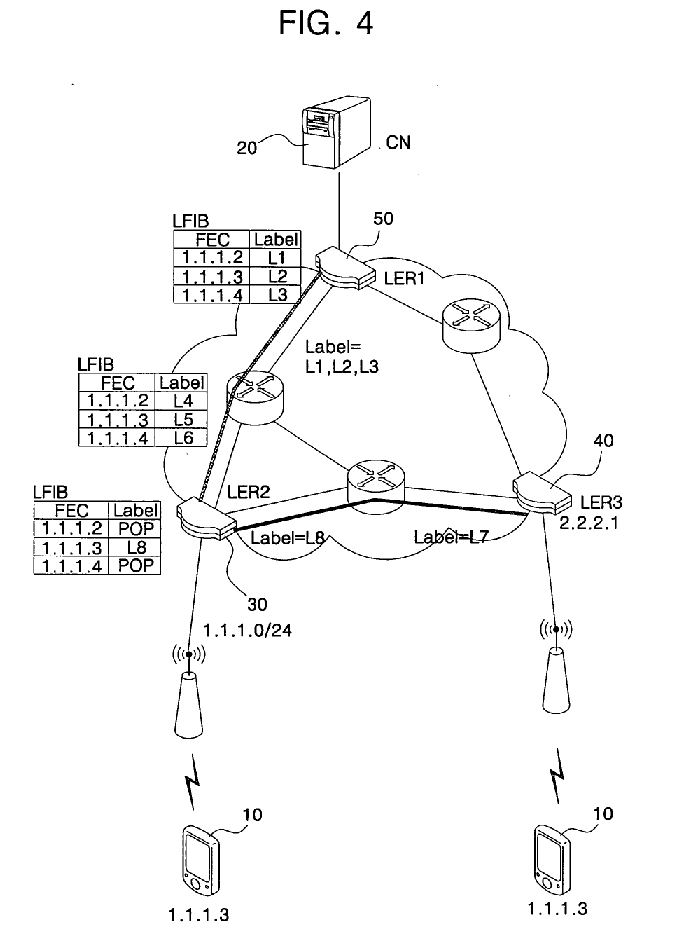

FIG. 4 is a packet flow when the MN moves in the MPLS network. That is, FIG. 4 shows the procedure of transmitting the LFIB and the packet in each LSR when the MN 10 having the address of 1.1.1.3 described in FIG. 3 moves from the HA area to the FA area.

In FIG. 3 when the MN 10 is not out of the HA area, the label is no longer assigned for the address of 1.1.1.3 in the LFIB table of the LER2. In contrast, in FIG. 4, it can be confirmed that a label (L8) is again assigned for the address of 1.1.1.3 (address of MN), and the packet is transmitted to a LER3 40 through a middle router.

The middle router positioned between the LER2 30 and the LER3 40 attaches a label (L7) to the packet input with the label (L8) attached, and transmits the packet to the LER3 40. The LER3 40 receives the packet, pops out the label (L8) from the received packet, performs IP routing, and transmits the packet to the MN 10.

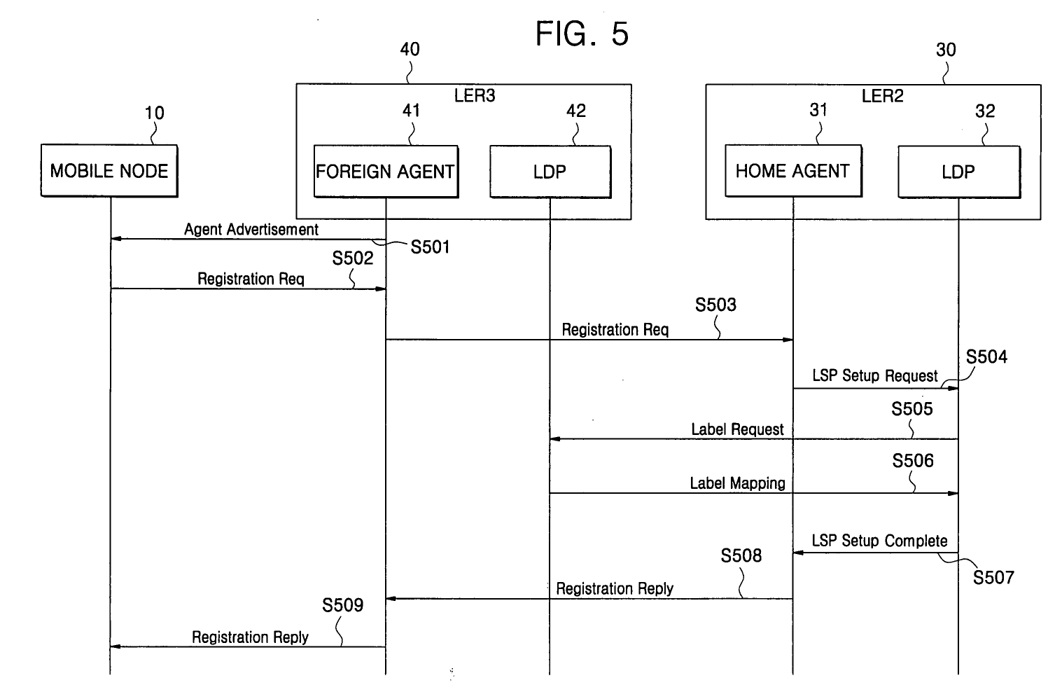

FIG. 5 is an operation flow for setting the LSP between agents when the MN moves. The MN 10 moves from an area of the LER2 30 to an area of the LER3 40, receives the agent advertisement from the FA 30 (Step 501), and transmits a registration request message to the HA 31 through the FA 41 (Step 502), thereby informing a new FA of its movement (Step 503). The HA 31 receives the registration request message, and requests the FA 41 to set the LSP to a Label Distribution Protocol (LDP) 32 (Step 504). The FEC is a CoA IP address of the MN, that is, the FA 41.

When the LDP 42 of the LER3 40 receives the label request message (Step 505), the LDP 42 transmits a label mapping message to the LER2 30 (Step 506). The LER2 30 pops out an out label for FEC 1.1.1.3 of its own LFIB table, and changes the out label to have a number of the assigned label. In matching with FIG. 4, the assigned label will be the label (L8). In this manner, the LER2 30 transmits the packet to the LER3 40 through MPLS packet forwarding for FEC 1.1.1.3.

As described above, FIG. 5 shows the procedure of setting the LSP from the HA to the FA when the MN moves. Summarizing the procedure of FIG. 5, it can be appreciated that four steps of registration request, label request, label mapping, and registration reply are performed.

As described in FIGS. 4 and 5, when the LSP is set using the host FEC and the MN moves, only the table of the LFIB changes, thereby making it possible to transmit the packet from the HA to the FA.

However, if the LSP is set using the host FEC (32 bits of prefix length), the LFIB table entry is increased in the middle routers positioned between the edge routers, thereby causing a drawback in extension. In order to overcome this drawback, a method of setting the LSP using a prefix FEC, not the host FEC, is used. However, even in this method, the edge router requires a procedure of referring to the LFIB table and a Routing Information Base (RIB), and therefore there is a drawback of increased time taken for packet forwarding.

The present invention is described below with reference to the accompanying drawings, in which exemplary embodiments of the present invention are shown.

When Multi-Protocol Label Switching (MPLS) is embodied using a host Forwarding Equivalence Class (FEC), there is a drawback in that a Label Forwarding Information Base (LFIB) table entry increases in middle routers. In order to overcome this defect, a method using a prefix FEC is described as follows.

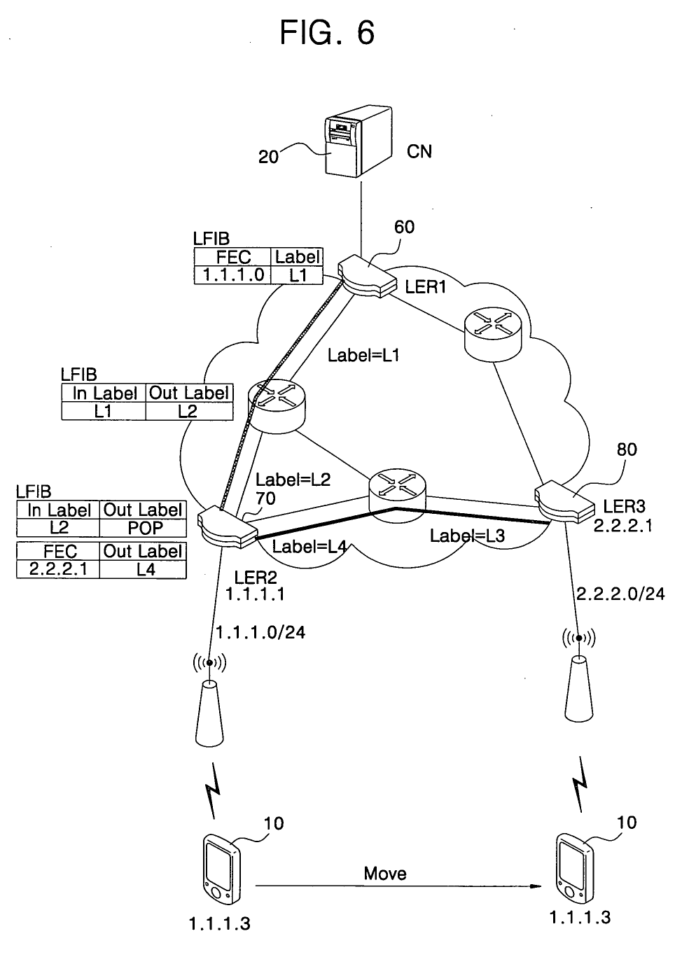

FIG. 6 is a flow of setting a Label Switching Path (LSP) using a prefix FEC according to the present invention.

In FIG. 6, each label switching router (LSR) (LER1, LER2, LER3, and middle router) creates the LFIB necessary for label switching, through a Label Distribution Protocol (LDP) operation. An input interface, an output interface, an in label, and an out label corresponding to each FEC constitute the LFIB.

In a description where the FEC is 1.1.1.0 in an LFIB table of the LERI 60, it can be appreciated that a prefix FEC is used. In other words, all Internet Protocols (IPs) corresponding to 1.1.1.x are assigned to one label (L1). The middle router receives a packet with the label (L1) attached, assigns a label (L2) as the out label to the packet, and transmits the packet. If the LSP from the LER1 60 to the LER2 70 is set to 1.1.1.0/24 as described above, the LSPs on a path through which the LSP passes maintain one LFIB entry.

When an MN 10 moves from an area of the LER2 70 to an area of the LER3 80, the LER2 70 refers to the LFIB table, pops out the label for the FEC having a destination address of 1.1.1.3, and transmits the FEC to an IP forwarding engine.

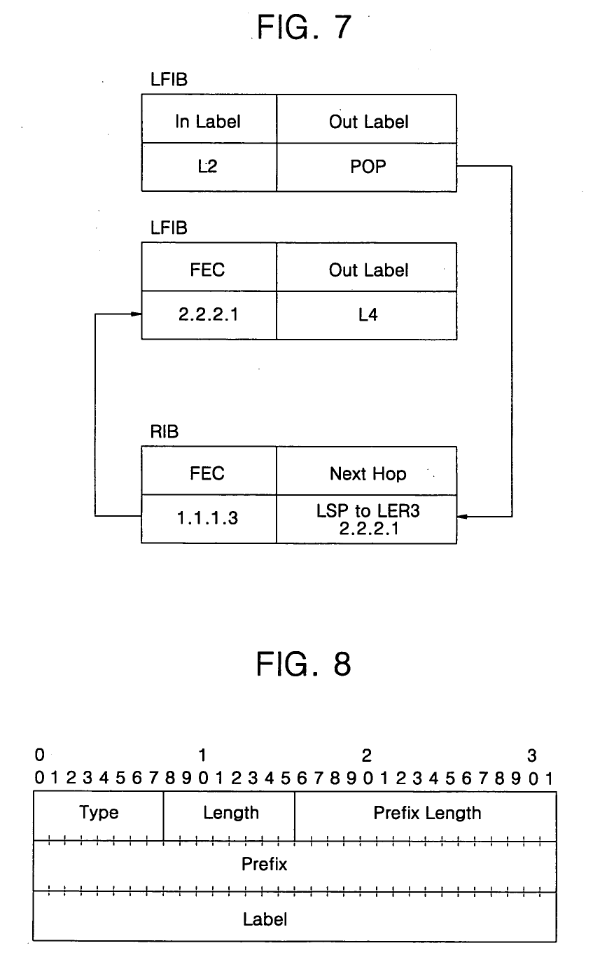

FIG. 7 is the procedure of referring to the routing table in setting the LSP using the prefix FEC. That is, FIG. 7 shows the details of the procedure of referring to the routing table in the LER2 70 which is in charge of the function of the HA when the MN 10 moves as in FIG. 6.

It is assumed that the MN 10 having the address of 1.1.1.3 moves from the area of the LER2 70 to the area of the LER3 80. Referring to the LFIB table of FIG. 7 managed by the LER 2 70, it can be appreciated that the packet transmitted from a correspondent node 20 to the MN 10 is attached to the label 2 and input to the LER2 70. The LER2 70 refers to the LFIB table, pops out the label for the FEC having the destination address of 1.1.1.3, and transmits the FEC to the IP forwarding engine. The IP forwarding engine recognizes that a next hop for FEC 1.1.1.3 is the LER3 80 having an address of 2.2.2.1 through a Routing Information Base (RIB), and transmits corresponding information to an MPLS forwarding engine. The MPLS forwarding engine searches for the LFIB entry being forwarded to the address of 2.2.2.1, recognizes that the out label is a label (L4), attaches the packet being forwarded to the address of 1.1.1.3 to the label (L4) and transmits the packet with the label attached.

When the LSP is set to the prefix FEC as mentioned above, there is an advantage in that the LSPs on the LSP maintain only one LFIB entry, whereas there is a disadvantage of performing a process of referring to the table several times, thereby delaying packet forwarding as long as a time taken to refer to the table.

An MPLS domain can form a hierarchical structure according to need. For this, each packet can include two or more labels using a structure called a label stack. Accordingly, when the label is encoded, a newly encoded label is inserted using a push function into an uppermost position of the label stack. When out of a corresponding hierarchy, one label is eliminated using a pop function from the uppermost position of the label stack. The corresponding packet is transmitted on the basis of the label at the uppermost position of the label stack. Each label is encoded by a total of 32 bits of which 20 bits substantially become the label. In the present invention, the LSP is set through the label-tunnel using the above label stack.

FIG. 8 is the structure of label mapping information according to the present invention. The label mapping information of FIG. 8 is added to a registration request message of an extended type.

A “Type” field represents the extension type of the registration request message. Here, the “type” field has a value of “35” representing the label mapping information. A “Prefix Length” field represents a length of a prefix, and a “Prefix” field represents information on the FEC for assigning the label. Furthermore, a “Label” field includes information on the label assigned to the FEC.

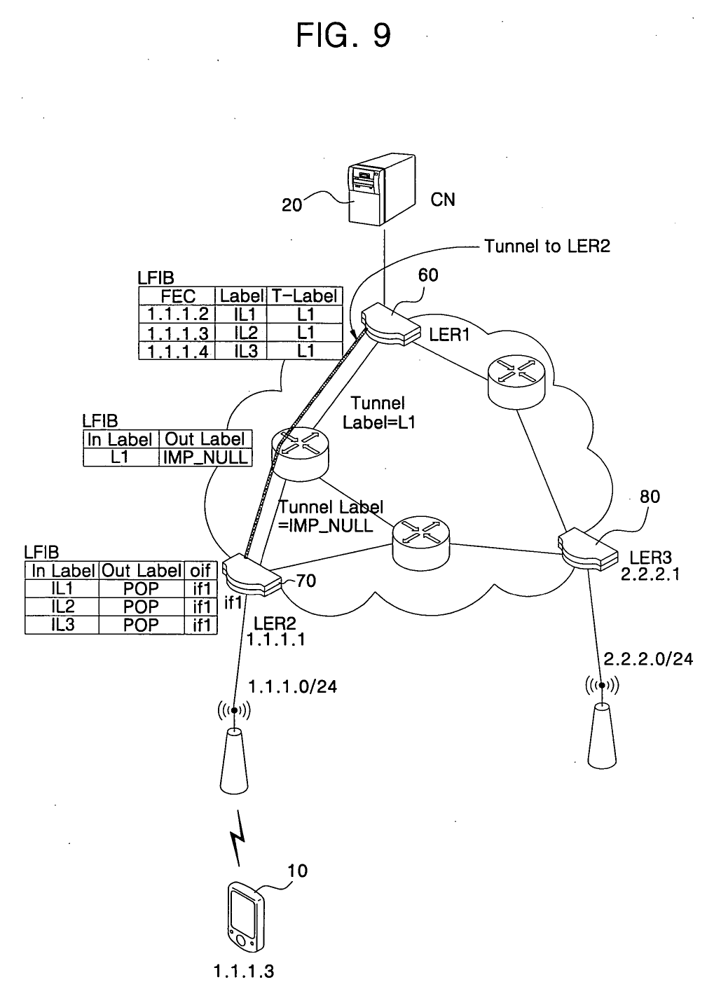

FIG. 9 is an LSP structure for MPLS-based mobile IP according to the present invention. According to the present invention, as in FIG. 9, label-tunnel LSPs are set between the LER1 60 and the LER2 70, and between the LER2 70 and the LER3 80.

In a description of the LFIB of the LER1 60, it can be appreciated that two labels are used. At each FEC, the in labels (IL1, IL2, and IL3) are set, and another tunnel-label (T-label) is separately set. These can be regarded as a kind of label stacking. In the present invention, two label stacks are used. The separate in label is set in each FEC of the 1.1.1.2, 1.1.1.3, and 1.1.1.4, but the tunnel labels are all set to be the same. This means that the packets having the three different FECs are all transmitted through the same tunnel.

End points of each set tunnel respectively become the IP address of the LER2 70 and the IP address of the LER3 80. The LER2 70 and the LER3 80 transmit the label mapping information of “implicit NULL” to the router positioned at its front, for “Penultimate Hop Popping”, which is a method for popping out the label in the router just before of an egress edge router and is intended to reduce a loop-up work for the packet.

For this, “implicit NULL” is distributed by an LDP of the egress edge router. The middle router to which the label “implicit NULL” is assigned by the egress edge router pops out the label directly itself and transmits the packet to a next-positioned edge router.

In FIG. 9, it can be confirmed that the out label of the middle router positioned between the LER1 60 and the LER2 70 is “IMP_NULL”. The LER2 70 receives the packet from the middle router, pops out the corresponding label from the packet, and performs IP forwarding through the look-up process.

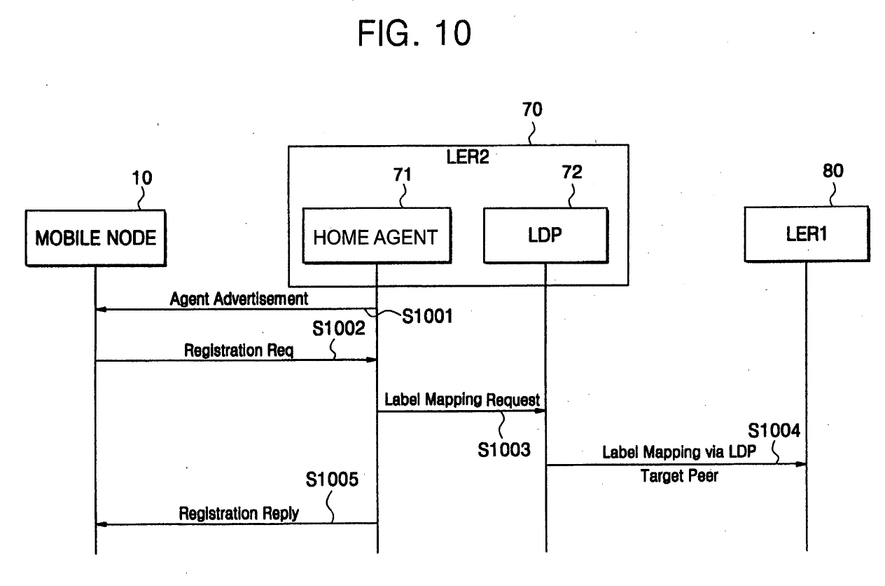

FIG. 10 is the procedure of setting the LSP for the MPLS-based mobile IP according to the present invention. That is, FIG. 10 shows the procedure of setting the LSP between the LER1 60 which is the ingress router and the LER2 70 which is the egress router when the MN 10 is positioned in the area of the LER2.70.

The MN 10 receives the agent advertisement from the HA 71 (Step 1001), and transmits a valid registration request message to the HA 71 (Step 1002). In response, the HA 71 transmits a label mapping request message to the LDP 72 (Step 1003). The registration request message has the mapping information added as in FIG. 8.

The LDP 72 receives the label mapping request message from the HA 71, and requests to transmit the label mapping message for the host FEC of the MN 10 to the LER1 60 where the correspondent node 20 is positioned (Step 1004). In this step, an LDP session is set using a target peer and the label is distributed between the LER1 60 and the LER2 70. The LDP 72 receives label information assigned to the corresponding MN 10 for the mapping message transmitted with the target peer, and generates an entry of the LFIB table of the LER2 70. Upon completion of setting the LSP, the HA 71 transmits a registration reply message to the MN 10 (Step 1005).

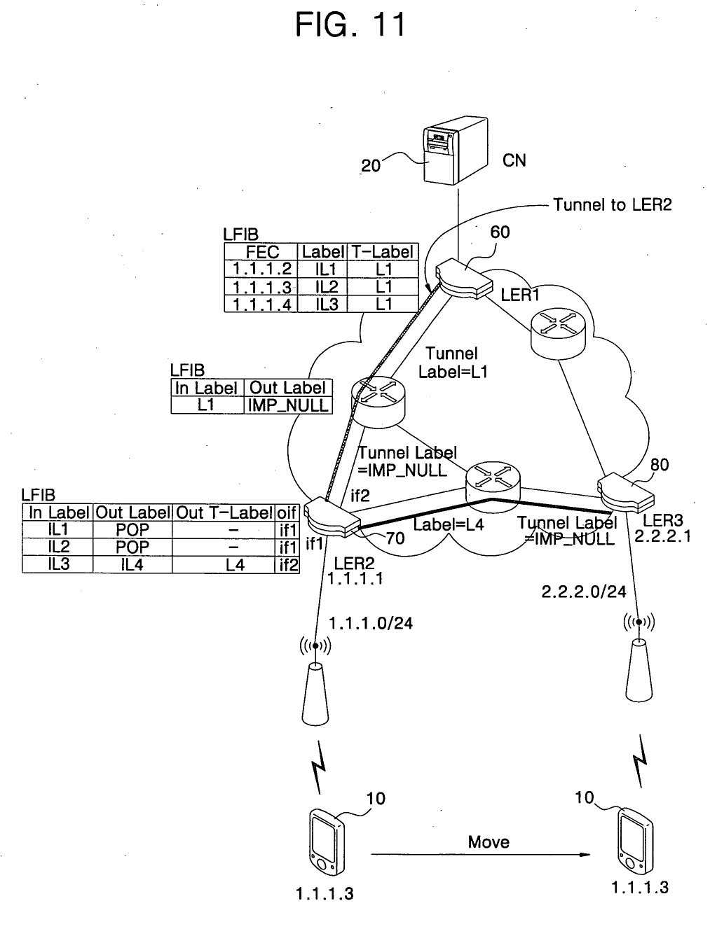

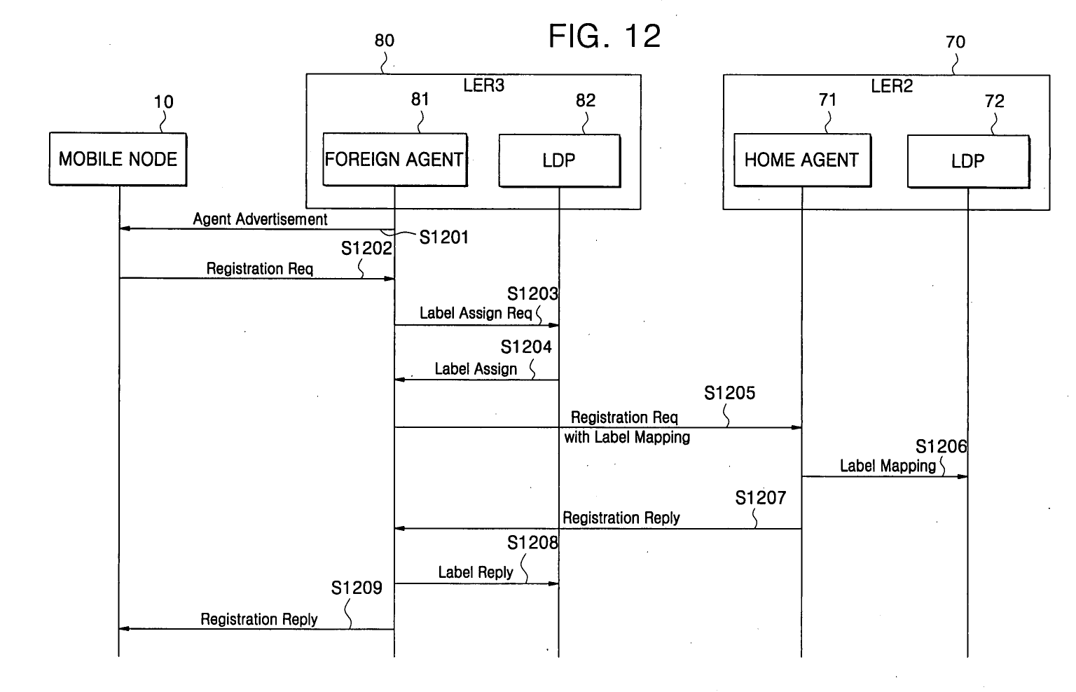

FIG. 11 is an LSP structure according to the present invention when the MN moves. That is, FIG. 11 shows how the LSP structure of FIG. 9 is changed when the MN 10 moves from the area of the LER2 70 to the area of the LER3 80.

When the MN 10 moves, the LFIB of the LER2 70 performing the function of HA changes. As shown in FIG. 11, it can be confirmed that, for the packet attached to the in label (IL3) assigned to the MN 10 and input, the out label is set as IL4, and an out T-label is set as L4. In other words, a tunnel is set between the LER2 70 and the LER3 80.

In a description of the LFIB of the LER2 70, it can be appreciated that the packet attached to the label IL3 and input is attached to IL4 as the out label, with L4 as the out T-label, and is output through the output interface 2. The LER3 80 receives the packet with a destination being the MN 10 having the address of 1.1.1.3, through the tunnel set between the LER2 70 and the LER3 80, and transmits the corresponding packet to the MN 10 through the IP routing for the received packet.

FIG. 12 is the procedure of distributing the label between the HA 71 and the FA 81 when the MN 10 moves. The MN 10 moved to the area of the LER3 80 receives the agent advertisement from the FA 81 (Step 1201), and transmits the registration request message (S1202) to the FA 81. The FA 81 receives the registration request message and transmits a label assignment request message to the LDP 82 (Step 1203). The LDP 82 is requested for label assignment from the FA 81, and assigns the label and transmits a label assignment message to the FA 81 (Step 1204).

The FA 81 receives the label assignment message and transmits the registration request message to the HA 71. The registration request message is transmitted with the label mapping information assigned from the LDP 82 and added (Step 1205). The registration request message includes a Care-of-Address (CoA). This should be identical with the end point of the set tunnel LSP from the LER2 70 to the LER3 80, that is, with the IP address of the FA 81. The label mapping information has the format shown in FIG. 8.

The HA 71 receives the registration request message including the label mapping information, and sets the LFIB of the LER2 80, using the IP address, the CoA, and the label mapping information of the MN 10. The setting of the LFIB is performed with the HA 71 providing the label mapping information to the LDP 72 (Step 1206). The LDP 72 sets the in label and the out label of the LFIB, using the FEC, the label information, and the CoA provided from the HA 71.

Upon setting of the LFIB, the HA 71 transmits the registration reply message to the FA 81 (Step 1207), and the FA 81 receives the registration reply message, transmits a label reply message to the LDP 72 informing that the label is normally mapped (Step 1208), and transmits the registration reply message to the MN 10 (Step 1209).

Comparing the procedure of FIG. 12 with the procedure of FIG. 5, it can be appreciated that the greatest difference is in a registration request process to a registration reply process from the FA to the HA. In FIG. 5, the registration request, label request, label mapping, and registration reply processes are performed, whereas in FIG. 12, only the registration request and registration reply processes including the label mapping information are performed. This means that, according to the present invention, the time taken to set the LSP can be reduced considerably.

According to the present invention, through the setting of the LSP using the label-tunnel between the edge routers, the number of entries and the routing look-up process are reduced. Also, the steps of transmitting and receiving the message for registration and label assignment are reduced so that network overhead is reduced and packet transmission efficiency increased.

While the present invention has been described with reference to exemplary embodiments thereof, it will be understood by those skilled in the art that various modifications in form and detail can be made therein without departing from the spirit and scope of the present invention as defined by the following claims.

What is claimed is:

1. A method of applying a mobile Internet Protocol (IP) to a Multi-Protocol Label Switching (MPLS) network, the method comprising:
performing label assignment using a label-tunnel configured by doubly stacking a label between a first edge router and a second edge router upon a Mobile Node (MN) moving from a position of the first edge router to a position of the second edge router; and
including label mapping information based on the assigned label in a registration request message in the second edge router, and transmitting the included label mapping information from the second edge router to the first edge router.

2. The method according to claim 1, wherein the label-tunnel is configured by doubly stacking an in label assigned at each host Forwarding Equivalence Class (FEC) and a tunnel label assigned for a prefix FEC.

3. The method according to claim 1, wherein the label mapping information comprises at least one of a prefix length, information on a FEC for assigning the label, and information on the label assigned to the FEC.

4. The method according to claim 1, wherein the label assignment comprises:
transmitting the registration request message to the second edge router from the MN; and
receiving the registration request message and performing a Label Distribution Protocol (LDP) label assignment in the second edge router.

5. The method according to claim 1, further comprising:
receiving the label mapping information and configuring a label forwarding table in the first edge router;
normally completing configuration of the label forwarding table in the first edge router, and transmitting a registration reply message from the first edge router to the second edge router; and
transmitting the registration reply message from the second edge router to the MN.

6. The method according to claim 5, wherein the label forwarding table is configured using at least one of an IP address of the MN, an IP address of the second edge router, and the label mapping information.

7. The method according to claim 1, further comprising:
performing the label assignment based on the label-tunnel and setting a label switching path between the first edge router and a third edge router where a correspondent node communicating with the MN is positioned; and
transmitting a packet from the correspondent node to the MN through the label switching path set between the first and second edge routers, and between the second and third edge routers.

8. The method according to claim 7, wherein transmitting a packet from the correspondent node to the MN comprises:
receiving the packet from the first edge router in a middle router positioned one hop before the second edge router, popping out a tunnel label of a corresponding packet, and transmitting the corresponding packet to the second edge router; and
referring to an in label included in the received packet in the second edge router and transmitting the packet from the second edge router to the MN.

9. A method of applying a mobile Internet Protocol (IP) to a Multi-Protocol Label Switching (MPLS) network, the method comprising:
setting a label switching route by using a label tunnel comprising a plurality of labels separately assigned with respect to each of a host Forwarding Equivalence Class (FEC) and a prefix FEC between a first edge router positioned at a Mobile Node (MN) and a second edge router positioned at a correspondent node carrying out mobile communication with the MN; and
transmitting a packet from the correspondent node to the MN through the set label switching route.

10. The method according to claim 9, wherein the label-tunnel is configured by doubly stacking an in label assigned at each host Forwarding Equivalence Class (FEC) and a tunnel label assigned for a prefix FEC.

11. The method according to claim 9, wherein the step of setting a label switching route comprises:
transmitting a registration request message from the MN to the first edge router; and
transmitting a label mapping message from the first edge router that received the registration request message to the second edge router through a Label Distribution Protocol (LDP) target peer.

12. The method according to claim 11, wherein the label matching message includes at least one of a prefix length, information on a FEC for assigning the label, and information on the label assigned to the FEC.

13. The method according to claim 5, further comprising:
performing the label assignment based on the label-tunnel and setting a label switching path between the first edge router and a third edge router where a correspondent node communicating with the MN is positioned;
receiving the packet from the first edge router in a middle router positioned one hop before the second edge router, popping out a tunnel label of a corresponding packet, and transmitting the corresponding packet to the second edge router; and
referring to an in label included in the received packet in the second edge router and transmitting the packet from the second edge router to the MN.

14. A Multi-Protocol Label Switching (MPLS) network comprising:
a Mobile Node (MN);
a first edge router adapted to receive a registration request message from the MN, to perform label assignment using a label-tunnel configured by doubly stacking a label, and to include and transmit label mapping information based on the assigned label in the registration request message upon the MN moving within its own service area; and
a second edge router adapted to receive the registration request message from the first edge router, to configure a label forwarding table based on the label mapping information included in the received registration request message, and to transmit a registration reply message to the first edge router upon the MN moving out of its own service area.

15. The MPLS network according to claim 14, wherein the label-tunnel is configured by doubly stacking an in label assigned at each host Forwarding Equivalence Class (FEC) and a tunnel label assigned for a prefix FEC.

16. The MPLS network according to claim 14, wherein the label mapping information comprises at least one of a prefix length, FEC information for assigning the label, and information on the label assigned to the FEC.

17. The MPLS network according to claim 14, wherein the label forwarding table is configured using at least one of an Internet Protocol (IP)address of the MN, an IP address of the second edge router, and the label mapping information.
